(19) United States
(12) Patent Application Publication
(10) Pub. No.: US 2005/0086124 A1
(43) Pub. Date: Apr. 21, 2005

(54) Method, system and program product for managing custom data during an electronic purchase

(75) Inventors: Glenn C. Godoy, Endwell, NY (US); Danny R. Hager, Binghamton, NY (US); Russell T. White JR., Conklin, NY (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/688,097

(22) Filed: Oct. 17, 2003

(51) Int. Cl. G06F 17/60

(52) U.S. Cl. 705/26

(57) ABSTRACT

Method, system and program product for managing custom data during an electronic purchase. Custom data is displayed and/or obtained using a custom data form. The custom data form is displayed when one or more attributes of items in the electronic purchase match the set of keys defined for the custom data form. Custom data obtained using the custom data form can be stored as a large object in a database.

### FIELD OF THE INVENTION

The invention relates generally to electronic purchases. Specifically, the invention provides a solution for managing custom data for items that are purchased electronically.

### BACKGROUND OF THE INVENTION

Electronic purchasing is being offered for increasingly complex transactions. Many of these transactions require that data be provided and/or obtained when a particular item is being purchased. For example, the purchase of a particular chemical may require that the purchaser complete a form that is submitted to the government. Further, many transactions between businesses also may result in custom data being required depending on the purchaser and/or the item(s) being purchased.

To date, solutions require that the custom data be presented and/or obtained as part of a separate process after the purchase request has been completed. Alternatively, custom code can be written for each situation that requires the presentation and/or collection of custom data. Both solutions are inefficient, inflexible, and prone to error.

As a result, a need exists for a method, system and program product for managing custom data during an electronic purchase. In particular, a need exists for a solution that automatically determines whether custom data needs to be displayed and/or obtained as part of a purchase, and displays and/or obtains the custom data before the purchase is completed.

### SUMMARY OF THE INVENTION

The invention provides a method, system and program product for managing custom data during an electronic purchase. Specifically, under the invention, one or more custom data forms are displayed to a user based on attributes of the electronic purchase. For example, a set of keys can be defined for the custom data form. If the value of each attribute in the set of keys matches the value of the corresponding attribute in the electronic purchase, the custom data form would be displayed. The custom data form can be used to collect custom data about an item, a group of items, and/or the purchase. Custom data collected can be stored in a database. For example, custom data collected from multiple fields on a custom data form can be concatenated and stored as a large object.

A first aspect of the invention provides a method of managing custom data during an electronic purchase, the method comprising: selecting an item for purchase; determining a set of attributes for the item; comparing the set of attributes to a set of keys; and displaying a custom data form if the set of attributes matches the set of keys.

A second aspect of the invention provides a method of managing custom data during an electronic purchase, the method comprising: selecting an item for purchase; obtaining purchase information for the item; determining a set of attributes for the item; comparing the set of attributes to a set of keys; displaying a custom data form if the set of attributes matches the set of keys; obtaining custom data using at least one input field in the custom data form; and storing the obtained custom data and purchase information in a database.

A third aspect of the invention provides a system for managing custom data during an electronic purchase, the system comprising: a selection system for allowing a user to select an item for purchase; an attribute system for determining a set of attributes for the item; a key system for comparing the set of attributes to a set of keys; and a form system for displaying a custom data form if the set of attributes matches the set of keys.

A fourth aspect of the invention provides a computer program product stored on a recordable medium for managing custom data during an electronic purchase, which when executed comprises: program code for allowing a user to select an item for purchase; program code for determining a set of attributes for the item; program code for comparing the set of attributes to a set of keys; and program code for displaying a custom data form if the set of attributes matches the set of keys.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system for managing custom data during an electronic purchase according to one embodiment of the invention;

FIG. 2 shows illustrative method steps for managing custom data according to another embodiment of the invention;

FIG. 3 shows illustrative method steps for displaying custom data according to still another embodiment of the invention; and

FIG. 4 shows an illustrative table configuration that stores custom data according to yet another embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the invention provides a method, system and program product for managing custom data during an electronic purchase. Specifically, under the invention, one or more custom data forms are displayed to a user based on attributes of the electronic purchase. For example, a set of keys can be defined for the custom data form. If the value of each attribute in the set of keys matches the value of the corresponding attribute in the electronic purchase, the custom data form would be displayed. The custom data form can be used to collect custom data about an item, a group of items, and/or the purchase. Custom data collected can be stored in a database. For example, custom data collected from multiple fields on a custom data form can be concatenated and stored as a large object.

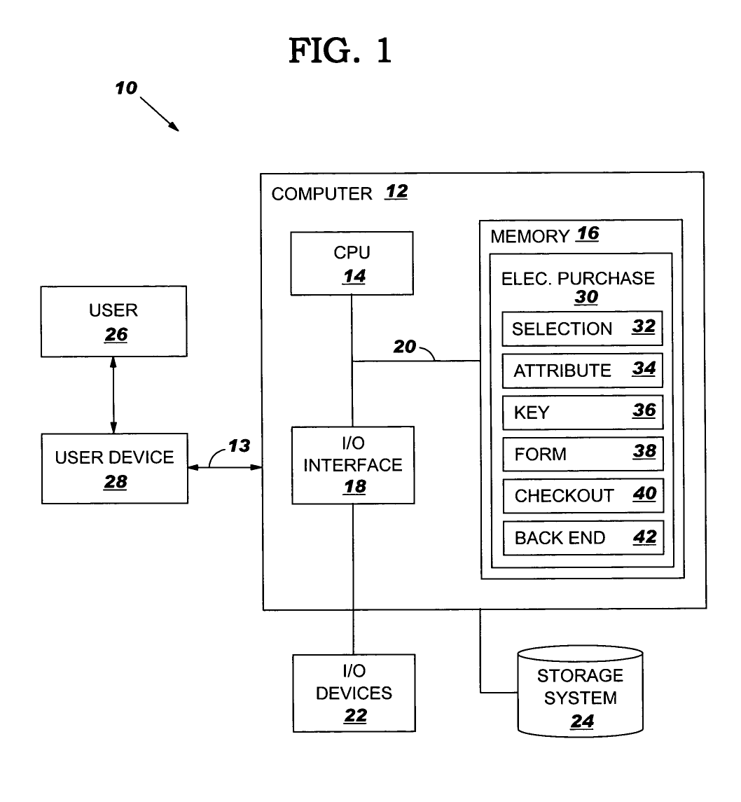

Turning to the drawings, FIG. 1 shows an illustrative system 10 for managing custom data during an electronic purchase. As depicted, user 26 operates user device 28 to select an item for purchase. User device 28 communicates with computer 12 via communications link 13 to request the electronic purchase. To this extent, communications link 13 can comprise a direct hardwired connection (e.g., serial port), or a network connection. In the case of the latter, the network can comprise an addressable connection in a client-server (or server-server) environment that may utilize any combination of wireline and/or wireless transmission methods. In this instance, the server and client may utilize conventional network connectivity, such as Token Ring, Ethernet, WiFi or other conventional communications standards. Further, the network can comprise any type of network, including the Internet, a wide area network (WAN), a local area network (LAN), a virtual private network (VPN), etc. Where the client communicates with the server via the Internet, connectivity could be provided by conventional TCP/IP sockets-based protocol, and the client would utilize an Internet service provider to establish connectivity to the server.

As shown, computer 12 generally includes central processing unit (CPU) 14, memory 16, input/output (I/O) interface 18, bus 20, external I/O devices/resources 22, and a storage system 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage system 24 may comprise any type of data storage for providing more static storage of data used in the present invention. As such, storage system 24 may include one or more storage devices, such as a magnetic disk drive or an optical disk drive. Moreover, similar to CPU 14, memory 16 and/or storage system 24 may reside at a single physical location, comprising one or more types of data storage, or be distributed across a plurality of physical systems in various forms. Further, memory 16 and/or storage system 24 can include data distributed across, for example, a LAN, WAN or a storage area network (SAN) (not shown).

I/O interface 18 may comprise any system for exchanging information to/from an external source. I/O devices 22 may comprise any known type of external device, including speakers, a CRT, LED screen, handheld device, keyboard, mouse, voice recognition system, speech output system, printer, monitor/display, facsimile, pager, etc. Bus 20 provides a communication link between each of the components in computer 12 and likewise may comprise any known type of transmission link, including electrical, optical, wireless, etc. In addition, although not shown, additional components, such as cache memory, communication systems, system software, etc., may be incorporated into computer 12.

Further, user device 28 typically includes the same elements as shown in computer 12 (e.g., CPU, memory, I/O interface, etc.). These have not been separately shown and discussed for brevity. It is understood that computer 12 and user device 28 comprise any type of computing devices capable of communicating with one or more other computing devices. For example, computer 12 and user device 28 could comprise any combination of a server, a client, a desktop computer, a laptop, a handheld device, a mobile phone, a pager, a personal data assistant, etc. It is understood, however, that if computer 12 or user device 28 is a handheld device or the like, a display could be contained within computer 12 or user device 28, and not as an external I/O device 22 as shown for computer 12.

Shown stored in memory 16 is an electronic purchase system 30 that allows user 26 to purchase one or more items electronically, for example, via the Internet. Electronic purchase system 30 is shown including a selection system 32, an attribute system 34, a key system 36, a form system 38, a checkout system 40, and a back end system 42. While these systems are shown implemented as part of electronic purchase system 30, it is understood that some or all of the systems can be implemented independently, combined, and/or stored in memory for one or more separate computers 12 that communicate over a network.

In general, user 26 operates user device 28 to select an item for purchase using selection system 32. After the item is selected, user 26 can select to complete the purchase using checkout system 40. While completing the purchase, form system 38 will display a custom form for the item. To this extent, form system 38 can interact with key system 36 to determine a set of keys for each custom form that has been defined and attribute system 34 to obtain the corresponding set of attributes for the item. When the set of attributes of the item matches the set of keys for a custom form, the custom form is displayed. Custom data can be displayed and/or collected using the custom form. After the purchase is completed, the purchase information and any custom data is forwarded to back end system 42, which completes the processing of the order.

As stated above, selection system 32 allows user 26 to browse and select one or more items for purchase. For example, selection system 32 can present user 26 with a hierarchical structure that categorizes various items available for purchase. User 26 can navigate the hierarchical structure to select an item, view additional information about the item, and select the item for purchase. Alternatively, user 26 can enter terms to search for one or more desired items. In any event, each item has a “set” of attributes. It is understood, that as used herein, the term “set” is used to refer to “one or more,”, e.g., a set of attributes comprises one or more attributes. The set of attributes allows the item to be categorized in the hierarchical structure and/or searched by user 26. The set of attributes for an item can include item attributes that comprise, for example, an item type, a cost, a description, a quantity available, sale restrictions, import/export restrictions, etc. As discussed further below, once an item is selected for purchase, its set of attributes can include additional “item-based” attributes related thereto and/or “purchase-based” attributes that are related to the purchase as a whole.

The invention allows one or more custom data “forms” for an item to be displayed to user 26 based on the set of attributes of the item. Each form can comprise data that is displayed using standard software (e.g., a web browser), and can include one or more fields that allow user 26 to enter data. For example, a form may include fields for entering address information, selecting a number of each item in the order, etc. In any event, each custom data form can display custom data to user 26. Further, a custom data form can be used to obtain custom data for the item that is required as part of the electronic purchase. In order to obtain the custom data, the custom data form can include one or more fields that allows user 26 to provide the custom data. Various types of fields can be used as are known in the art. Further, default selections and/or field data can be provided for some or all of the fields as is known in the art.

To determine whether a custom data form should be displayed for an item, a set of keys is first associated with each form. Each key in the set of keys comprises an attribute and a corresponding value or set of values that constitute a match of the attribute. The set of keys can be generated based on the data that is displayed and/or collected using the form. The set of keys can then be compared with the corresponding attributes of the item to determine if there is a match. When a match is found, the custom data form is displayed.

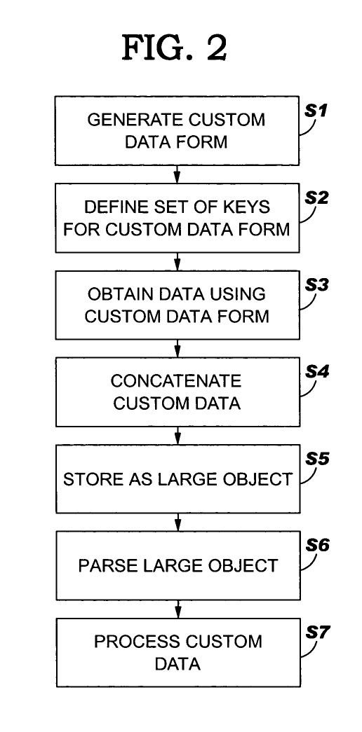

FIG. 2 shows illustrative method steps for obtaining custom data using a custom data form that can be carried out by the various systems shown in FIG. 1 according to one embodiment of the invention. In step S1, form system 38 (FIG. 1) can generate a custom data form that includes one or more fields. In step S2, key system 36 (FIG. 1) can define a set of keys for the custom data form that are used to determine whether the corresponding custom data form is to be displayed for an item.

In step S3, form system 38 can obtain custom data using the custom data form. In step S4, form system 38 can concatenate the custom data from each field in the custom data form for storage. In step S5, storage system 25 (FIG. 1) can store the concatenated custom data in a database as a large object. The large object comprises a database field for storing large amounts of data, and can comprise a Character Large Object (CLOB) for storing character data, a Binary Large Object (BLOB) for storing binary data, or a variant or combination thereof. Use of the large object or the like allows for a great deal of flexibility in the implementation of the invention. For example, changes can be made to the custom data that is obtained by a custom data form (e.g., add and/or remove a field on the form) without changing the data storage scheme (e.g., database schema). However, it is understood that the invention is not limited to the use of a large object. As a result, any data storage solution can be used.

When concatenated and stored as a large object, the custom data can be parsed in step S6 by back end system 42 (FIG. 1) to determine the custom data obtained for one or more of the fields in the custom form. In step S7, back end system 42 can process the custom data. Back end system 42 can perform the processing required to complete the electronic purchase, and may use the custom data for some of these functions. For example, back end system 42 can notify shipping, adjust inventory, generate labels, notify accounting, generate paperwork to conform to regulations, verify payment, etc.

In an electronic purchase, the custom data forms can be displayed to user 26 (FIG. 1) along with one or more forms that are used to obtain purchase information. Checkout system 40 (FIG. 1) can obtain purchase information for the electronic purchase using, for example, an electronic shopping cart. Using the electronic shopping cart, user 26 can select an item for purchase by “adding” the item to the electronic shopping cart using selection system 32 (FIG. 1). User 26 can continue to browse other items on the seller's web site, add additional items to the electronic shopping cart, and/or remove items from the electronic shopping cart. Should user 26 decide to purchase the item(s) in the shopping cart, user 26 can select to “checkout” the electronic shopping cart.

Once checkout is selected, checkout system 40 can present user 26 with one or more forms that obtain purchase information. The purchase information includes, for example, additional item attributes related to the purchase and purchase attributes. The additional item attributes comprise attributes that are required for each item purchased. For example, the item attributes may include a quantity purchased, an item discount, a tax, a shipping charge, etc. Purchase attributes comprise attributes that are required for each electronic purchase as a whole. For example, purchase attributes may include contact information for the purchaser, payment information, shipping information, a customer discount, etc. Once entered by user 26, the set of attributes for each item can include the item attributes and purchase attributes. As a result, a key in the set of keys may specify a value for an item attribute (e.g., item type or quantity), and/or a purchase attribute (e.g., shipping country) that is used to determine if a custom form should be displayed to user 26.

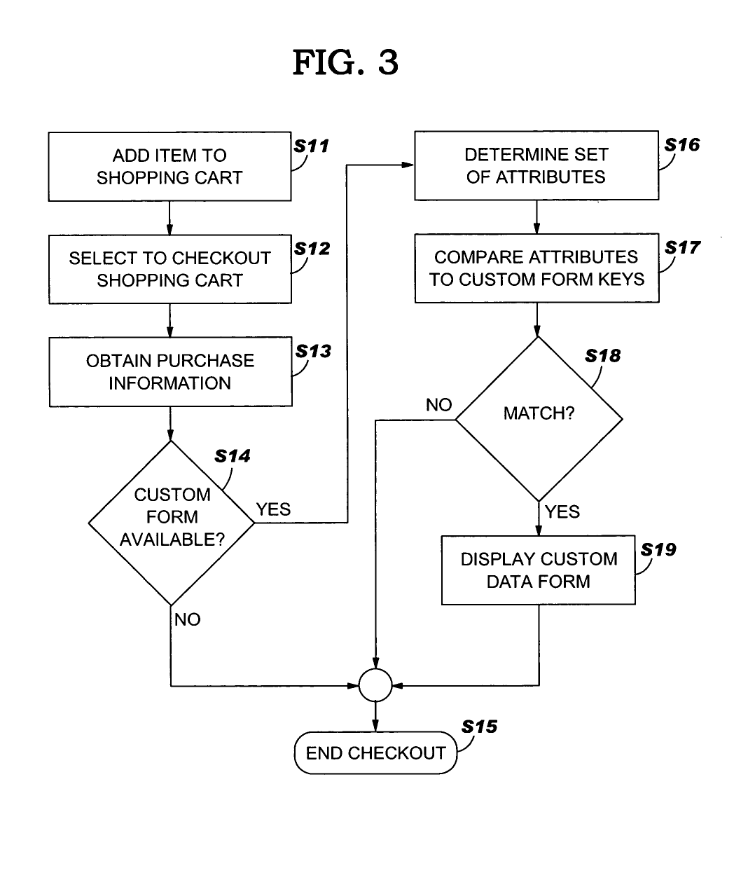

FIG. 3 shows illustrative method steps for displaying a custom data form that can be carried out by the various systems shown in FIG. 1 according to one embodiment of the invention. In step S11, user 26 (FIG. 1) can add an item to an electronic shopping cart using selection system 32 (FIG. 1). In step S12, user 26 can select to checkout the electronic shopping cart. In step S13, checkout system 40 can obtain purchase information by displaying one or more forms to user 26. In step S14, form system 38 can determine if a custom data form is available. If no custom data form is available, then the process can proceed to the end of the checkout in step S15. If a custom data form is available, then attribute system 34 can determine a set of attributes for the item in step S16. In step S17, key system 36 can compare the set of attributes to the set of keys for each available custom data form. To this extent, it is understood that the set of attributes determined by attribute system 34 may include all attributes for an item (e.g., item attributes and purchase attributes), or only the attributes that are included in the set of keys for one or more custom data forms. In step S18, key system 36 can determine if the attributes for the item match the set of keys for the custom data form. If the attributes do not match, then the process can continue to the end of the checkout in step S15. However, if the attributes match, then form system 38 can display the custom data form in step S19, before proceeding to the end of the checkout in step S15.

It is understood that the method steps are shown only for purposes of illustration. As a result, the order and/or type of steps performed could be varied under the invention. Further, it is understood that one or more of the steps shown may be repeated for an electronic purchase. For example, steps S13-S19 could be repeated for each item being purchased. Additionally, steps S17-S19 could be repeated when multiple custom data forms are available. Still further, steps 14-19 could also be performed prior to step S13 when, for example, purchase information is not included in the set of keys for a custom form. It is also understood that a “match” can be determined using any solution for comparing two values. For example, the comparison can require that the attribute and the key be exactly the same, within a specified range, greater than a value, less than a value, etc. Further, for character data, a match may be found when the attribute includes a substring, starts with a substring, ends with a substring, etc. Additionally, upper and lower case versions of a character could return a match or be considered distinct.

A custom data form may be displayed for each individual item purchased, each group of items purchased, and/or the entire order. For example, company A may request an electronic purchase that includes five units of chemical B, three units of software C, and three units of microscopes D. In this case, the sale of each unit of chemical B may require a government form. Since five units of chemical B are purchased, then the custom data form used to obtain the information for the government form would be displayed five times. Further, a custom data form may be displayed when the combination of one or more units of software C and one or more units of microscopes D are selected to notify the purchaser of a particular benefit that is available. Since three units of each have been selected, this custom data form would be displayed once. Still further, all purchases by company A may require a custom data form to obtain shipping information and contract authorization under an agreement between the seller and purchaser. Since company A is the purchaser, this custom data form will be displayed. As a result, a total of seven custom data forms would be displayed for the electronic purchase.

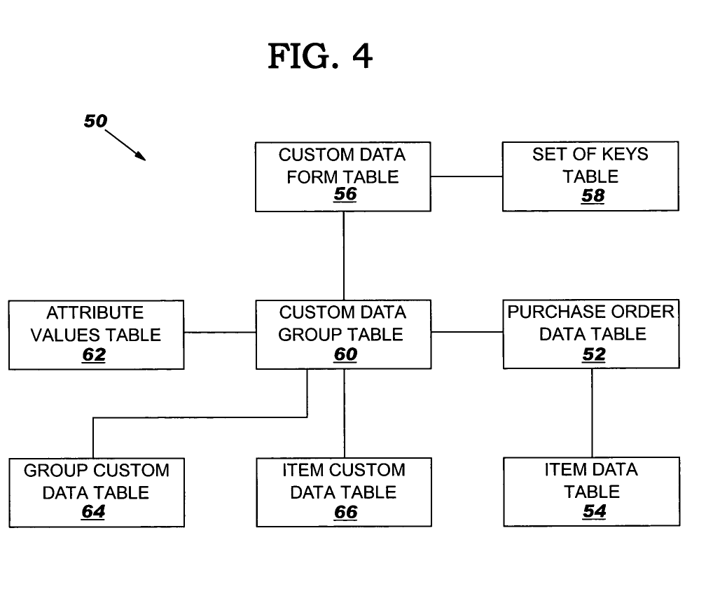

FIG. 4 shows an illustrative configuration 50 of database tables that manage the custom data according to one embodiment of the invention. Data for an electronic purchase order is stored in a purchase order table 52 and an item table 54. Purchase order table 52 can store the purchase attributes for the purchase as a whole as described above, while item table 54 can store the item attributes for each item included in the electronic purchase. However, custom data that is obtained using one or more custom data forms can be stored as a large object in either a group custom data table 64 or an item custom data table 66 as described further below.

As previously discussed, custom data can be obtained using one or more custom data forms. Custom data form table 56 can include an entry for each custom data form that has been defined. Set of keys table 58 includes one or more entries for each entry in custom data form table 56 that define the set of keys for the corresponding custom data form. During the electronic purchase, custom data form table 56 can be queried to determine if any custom data forms are present. If one or more custom data forms are present, then a list of the custom data forms can be obtained from custom data form table 56. Further, for each custom data form, one or more entries from set of keys table 58 can be obtained to determine the set of keys for the corresponding custom data form. One or more custom data forms may have the same set of keys. For each unique set of keys, the attribute values for the purchase order are obtained from purchase order table 52 and/or item table 54 and compared to the values in the set of keys to determine if there is a match.

When one or more items in an electronic purchase match a particular set of keys, the corresponding custom data form is displayed. When custom data is obtained using the custom data form, these items can comprise a custom data group. The custom data group comprises a set of items for which custom data has been obtained. Custom data group table 60 can store an entry for each custom data group for the electronic purchase. The attributes and attribute values that matched the set of keys to create the custom data group can be stored in one or more entries in attribute values table 62. Attribute values table 62 allows each item in the purchase order that belongs to a custom data group to be identified at a later time.

As stated above, custom data may be collected once for all items in a group (e.g., once for five units of chemicals) or once for each item in a group (e.g., once for each unit of chemicals purchased). As a result, each entry in custom data group table 60 includes an indication as to whether the custom data form was displayed once for the entire custom data group, or once for each item in the custom data group. The custom data that was obtained can be stored in an entry in group custom data table 64 or item custom data table 66, depending on how the custom data form was displayed. Group custom data table 64 includes an entry that stores in a large object the custom data that was collected when the custom data form was displayed once for all the items in the custom data group. Group custom data table 66 includes an entry that stores in a large object the custom data when a custom data form was displayed once for each item in the custom data group.

In order to process a purchase order, the entry for the purchase order can be identified in purchase order table 52. Custom data group table 60 can be queried to determine if any entries correspond to the purchase order entry. When an entry in custom data group table 60 is found, the attribute values can be obtained from attribute values table 62 to determine the item(s) in the purchase order that belong to the custom data group. Based on where the custom data was stored, an entry in the group custom data table 64 and/or entries in the item custom data table 66 can be retrieved. In either case, the large object for each entry can be parsed to obtain the data entered for each field in the custom data form. The appropriate custom data form can be located by accessing the entry in custom data form table 56 that corresponds to the entry in custom data group table 60, and the parsed custom data can be displayed in the custom data form. Alternatively, the entry in custom data form table 56 could use an alternative form that corresponds to the custom data form, but provides the custom data in a display only format.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of managing custom data during an electronic purchase, the method comprising:
selecting an item for purchase;
determining a set of attributes for the item;
comparing the set of attributes to a set of keys; and
displaying a custom data form if the set of attributes matches the set of keys.

2. The method of claim 1, wherein the selecting step comprises:
adding the item to an electronic shopping cart;
selecting to checkout the electronic shopping cart; and
obtaining purchase information for the electronic purchase.

3. The method of claim 2, wherein the custom data form is displayed after the obtaining step.

4. The method of claim 1, further comprising generating the custom data form for the item.

5. The method of claim 1, further comprising obtaining custom data using the custom data form.

6. The method of claim 5, further comprising storing the obtained custom data in a database.

7. The method of claim 6, wherein the storing step comprises:
concatenating custom data obtained using at least two input fields in the custom data form;
storing the concatenated custom data as a large object in the database.

8. The method of claim 7, further comprising parsing the concatenated custom data to determine the custom data obtained for one of the at least two fields.

9. The method of claim 1, wherein the custom data form is displayed once for a plurality of items that match the set of keys.

10. A method of managing custom data during an electronic purchase, the method comprising:
selecting an item for purchase;
obtaining purchase information for the item;
determining a set of attributes for the item;
comparing the set of attributes to a set of keys;
displaying a custom data form if the set of attributes matches the set of keys;
obtaining custom data using at least one input field in the custom data form; and
storing the obtained custom data and purchase information in a database.

11. The method of claim 10, wherein the storing step comprises:
concatenating custom data obtained for a plurality of input fields;
storing the concatenated custom data as a large object in the database.

12. The method of claim 11, wherein the storing step further comprises storing an entry in a custom data group table for a custom data group, wherein the custom data group includes each item in the electronic purchase that matches the set of keys.

13. The method of claim 12, wherein the storing step further comprises:
storing the large object in an entry in a group custom data table if the custom data form is displayed once for the custom data group; and
storing the large object in an entry in an item custom data table if the custom data form is displayed for each item in the custom data group.

14. A system for managing custom data during an electronic purchase, the system comprising:
a selection system for allowing a user to select an item for purchase;
an attribute system for determining a set of attributes for the item;
a key system for comparing the set of attributes to a set of keys; and
a form system for displaying a custom data form if the set of attributes matches the set of keys.

15. The system of claim 14, further comprising a checkout system for obtaining purchase information for the item.

16. The system of claim 14, further comprising a storage system for storing custom data, wherein the form system further obtains the custom data using the custom data form.

17. The system of claim 16, wherein the storage system includes:
a custom data group table for storing an entry for a custom data group, wherein the custom data group includes each item in the electronic purchase that matches the set of keys;
a group custom data table for storing an entry for the custom data for the custom data group if the custom data form is displayed once for the custom data group; and an item custom data table for storing an entry for the custom data for each item in the custom data group if the custom data form is displayed once for each item in the custom data group.

18. A computer program product stored on a recordable medium for managing custom data during an electronic purchase, which when executed comprises:
program code for allowing a user to select an item for purchase;
program code for determining a set of attributes for the item;
program code for comparing the set of attributes to a set of keys; and
program code for displaying a custom data form if the set of attributes matches the set of keys.

19. The computer program product of claim 18, further comprising:
program code for obtaining purchase information for the item;
program code for obtaining custom data using the custom data form; and
program code for storing the custom data and the purchase information.

20. The computer program product of claim 19, further comprising program code for processing the custom data.
